(19) United States
(12) Patent Application Publication
(10) Pub. No.: US 2026/0213211 A1
(43) Pub. Date: Jul. 23, 2026

(54) ANODE-FREE ELECTROCHEMICAL CELL

(71) Applicants: FUNDACIÓN CENTRO DE INVESTIGACIÓN COOPERATIVA DE ENERGÍAS ALTERNATIVAS CIC ENERGIGUNE FUNDAZIOA, Vitoria-Gasteiz, Álava (ES); UNIVERSIDAD DEL PAÍS VASCO/EUSKAL HERRIKO UNIBERTSITATEA, Leioa, Vizcaya (ES)

(72) Inventors: Shanmukaraj DEVARAJ, Vitoria-Gasteiz, Álava (ES); Begoña ACEBEDO, Vitoria-Gasteiz, Álava (ES); Elena GONZALO, Vitoria-Gasteiz, Álava (ES); Aitor VILLAVERDE OREJÓN, Vitoria-Gasteiz, Álava (ES); Michel ARMAND, Vitoria-Gasteiz, Álava (ES); Idoia RUIZ DE LARRAMENDI, Leioa, Vizcaya (ES)

(21) Appl. No.: 19/140,847

(22) PCT Filed: Oct. 5, 2023
(86) PCT No.: PCT/EP2023/077597

§ 371 Date: Jun. 18, 2025

(30) Foreign Application Priority Data
Dec. 23, 2022 (EP) 22383285.8

(51) Int. Cl. H01M 4/62; H01M 4/131; H01M 4/505; H01M 4/525; H01M 10/0569; H01M 10/058

(52) U.S. Cl. CPC H01M 4/628; H01M 4/131; H01M 4/505; H01M 4/525; H01M 10/0569; H01M 10/058; H01M 2300/0037

(57) ABSTRACT

A cell, an energy storage or energy supply system including the cell, and to the use of the cell or the supply system to store or supply electricity.

### TECHNICAL FIELD

The present invention relates to the field of electrochemical cells, in particular with anode-free electrochemical cells.

### BACKGROUND

Anode-free electrochemical battery cells are a likely solution to achieve high energy density and solve some of the issues of anode-based batteries. In particular, anode-free electrochemical cells show intrinsic high energy and safety. However, these type of cells have some drawbacks such as fast capacity decay, low Coulombic efficiency (CE) and poor lifespan due to rapid cell cycle degradation.

Huang et al. (ACS Appl. Mater. Interfaces 2022, 14, 26724-26732) described an anode-free electrochemical cell comprising a cathode composite material with lithium oxalate as additive salt. This set up shows an improvement in the cell life-cycle and in its average coulombic efficiency. Nevertheless, the use of lithium oxalate in the cathode composite material still has issues that need to be improved such as a high cutoff potential that makes impossible the use of most electrolyte solvents and cathode materials due their decomposition. In addition, due to the high potential required for oxidizing lithium oxalate, the current collector of said cell may have corrosion problems.

In this sense, there is still an ongoing need to develop anode-free electrochemical cells with enhanced overall performance.

### BRIEF DESCRIPTION OF THE INVENTION

The authors of the present invention have developed an anode-free electrochemical cell comprising an electrode that comprises a mixture comprising: an active material, and a salt comprising a C₃₋₆ oxocarbon anion group; an electrolyte; a separator; and two current collectors, with better performance that other cells of the state of the art. Authors have observed that the performance of the cell of the invention is significantly improved by the use of an electrode comprising salt comprising a C₃₋₆ oxocarbon anion group. In addition, the authors have observed than the cell of the invention not having an anode has a better intrinsic energy density and safety in addition to a reduced weight and manufacture cost than cells comprising an anode. Moreover, some cells having graphite or silicon based anodes show additional disadvantages as capacity limitation and volume expansion that the cell of the present invention has overcame.

Thus, a first aspect of the invention is directed to an anode-free electrochemical cell comprising:
an electrode comprising a mixture, wherein said mixture comprises:
   an active material, and
   a salt comprising a C₃₋₆ oxocarbon anion group;
an electrolyte;
a separator; and
two current collectors;
wherein the electrode is a cathode.

The cell of the present invention is configured to act as an energy storage and supply system i.e. it is configured to be reversibly charged and discharged. Therefore, in a second aspect, the present invention is directed to an energy storage or supply system comprising one or more cells as defined above.

Additional aspects of the present invention are directed to the use of the cell of the present invention in any of its particular embodiments or of the energy storage or supply system of the present invention in any of its particular embodiments, to store or supply energy.

Another additional aspect is directed to the method of manufacturing the cell of the present invention.

Moreover, additional aspects are directed to a method to storing or supplying energy comprising the cell of the present invention in any of its particular embodiments or the energy storage or supply system of the present invention in any of its particular embodiments.

### FIGURES

These figures are for illustrative purposes only and are not intended to limit the scope of the present invention.

FIG. 1 shows an embodiment of the cell (1) comprising current collectors (2, 3), electrolyte (4) and an electrode mixture (5).

FIG. 2 shows the initial charge/discharge profiles of an embodiment of the cell showing voltage versus specific capacity (mAh/g) results of (i) initial charge and (ii) initial discharge.

FIG. 3 shows the charge capacity of the cell with a composite comprising (i) lithium oxalate or (ii) lithium squarate salts as cathode, at C/10 with a cut off potential at 4.3V.

### DETAILED DESCRIPTION OF THE INVENTION

Unless defined otherwise, all technical and scientific terms used herein have the same meaning as commonly understood to one of ordinary skill in the art to which this disclosure belongs. As used herein, the singular forms “a” “an” and “the” include plural reference unless the context clearly dictates otherwise.

In the context of the present invention, the term “oxocarbon anion” refers to an oxocarbon anion consisting of carbon, oxygen and optionally hydrogen atoms. In an embodiment, the salt comprises an oxocarbon anion, in particular a C₃₋₆ oxocarbon anion. In a particular embodiment, the salt of the mixture of the electrode consist of an oxocarbon anion such as a C₃₋₆ oxocarbon anion and at least a counterion; preferably wherein the counterion is at least a lithium (I) cation.

In the context of the present invention, the term “C₃₋₆ oxocarbon anion” refers to an oxocarbon anion consisting of carbon, oxygen and optionally hydrogen atoms, having between 3 and 6, preferably between 4 and 6, more preferably 4 or 5, carbon atoms. In a particular embodiment, the oxocarbon anion consists of carbon and oxygen atoms.

As defined above, in a first aspect, the present invention refers to an anode-free electrochemical cell comprising:
an electrode comprising a mixture; wherein the mixture comprises:
   an active material, and
   a salt comprising a C₃₋₆ oxocarbon anion group;
an electrolyte;
a separator; and
two current collectors;
   wherein the electrode (5) is a cathode.

In an embodiment, the cell of the invention is an electrochemical cell or battery; preferably an anode-free electrochemical cell or battery; more preferably an anode-free lithium ion cell or battery.

In the context of the present invention the term “anode-free” regarding the cell of the present invention means that said cell does not have an anode, in particular the cell only has one electrode which is a cathode.

### Electrodes

In an embodiment, the electrode of the cell comprises a mixture comprising (i) an active material, (ii) a binder, (iii) a conductive material, and (iv) a salt comprising a C₃₋₆ oxocarbon anion group; preferably a lithium salt comprising a C₃₋₆ oxocarbon anion group.

In another embodiment, the electrode of the cell consists of a mixture comprising (i) an active material, (ii) a binder, (iii) a conductive material, and (iv) a salt comprising a C₃₋₆ oxocarbon anion group; preferably a lithium salt comprising a C₃₋₆ oxocarbon anion group.

In yet another embodiment, the electrode of the cell consists of a mixture consisting of (i) an active material, (ii) a binder, (iii) a conductive material, and (iv) a salt comprising a C₃₋₆ oxocarbon anion group; preferably a lithium salt comprising a C₃₋₆ oxocarbon anion group.

In an embodiment, the mixture is a composite; preferably a solid composite. In an alternative embodiment, the mixture is a composite which has been casted on one of the two current collectors of the cell in particular, which has been casted on the surface of one of the two current collectors of the cell. In a more particular embodiment, the mixture of the electrode form a layer on the surface of one of the two current collectors of the cell of the invention. In the context of the present invention “a composite” is understood as a combination of two materials or more materials with different physical and chemical properties as known in the art.

The expression “active material” refers to what is commonly understood in the battery field such as a material that intervenes in the chemical reaction of the cell.

In a particular embodiment, the active material of the mixture of the electrode is a cathode active material.

In an embodiment, the active material comprises a metal element; preferably an alkali metal element; more preferably an alkali metal selected from the group consisting of sodium, potassium, lithium and mixtures thereof; preferably lithium. In a more particular embodiment the active material is a lithium compound.

In a particular embodiment, the active material is an intercalation material, a conversion material or a combination thereof.

In the context of the present invention the expression “intercalation material” refers to a layered material with molecules or ions included or inserted as known in the art regarding batteries and electrochemical cells, such as graphite or transition metal dichalcogenides. In the context of the present invention the expression “conversion material” refers to conversion-type electrode materials as known in the art regarding batteries and electrochemical cells.

In a particular embodiment, the active material comprises a compound selected from: phosphates, oxides, chalcogen-based compounds such as compounds comprising S, Se and/or Te; halogen-based compounds such as fluoride-based compounds or a mixture thereof; preferably the active material comprises a phosphate, an oxide or mixtures thereof.

In another particular embodiment, the active material consist of a compound selected from: phosphates, oxides, chalcogen-based compounds such as compounds comprising S, Se and/or Te; halogen-based compounds such as fluoride-based compounds or mixtures thereof; preferably the active material is a phosphate, an oxide or mixtures thereof.

Non-limiting examples of suitable phosphates as active materials are lithium-containing phosphates; preferably lithium metal phosphates such as such as Li₁₋ₓFeMnₓPO₄ wherein 0<x≤1 or Li₃V₂(PO₄)₃; lithium metal fluorophosphates such as Li₂FePO₄F, LiV₁₋ₓMₓPO₄F wherein M is Al or Cr, or Li₃(VO₁₋ₓPO₄)₂F₁₊₂ₓ wherein 0≤x≤0.5; or mixtures thereof.

Non-limiting examples of suitable halogen-based compounds as active materials are halogen-based compounds comprising a halogen selected from F, I, Br and mixtures thereof; preferably halogen-based compounds comprising F.

Non-limiting examples of suitable chalcogen-based compounds are chalcogen-based compounds comprising S, Se and/or Te; preferably transition metal dichalcogenides with formula ME₂, wherein M is a transition metal and E is selected from S, Se, and Te.

Non-limiting examples of suitable oxides as active materials are metallic oxides such as vanadium oxide V₂O₅; preferably a metallic oxide selected from: lithium nickel manganese cobalt oxide (NMC) such as LiNiₓMn_{1-x-y}CO_{y}O₂ wherein x is below or equal to 0.9 and y is over or equal to 0.05, preferably LiNiₓMn_{1-x-y}CO_{y}O₂ wherein x is below or equal to 0.6 and y is over or equal to 0.20; lithium nickel manganese oxide (LNMO); lithium nickel cobalt aluminium oxide (NCA); lithium manganese oxide (LMO); lithium cobalt oxide (LCO); lithium nickel oxide (LNO) or mixtures thereof.

In a particular embodiment, the active material is an oxide; preferably a lithium containing oxide; more preferably a lithium transition metal oxide such as lithium cobalt oxide (LCO), lithium manganese oxide (LMO), lithium nickel manganese cobalt oxide (NMC), and lithium nickel cobalt aluminium oxide (NCA); even more preferably is lithium nickel manganese cobalt oxide (NMC); even much more preferably is Li_{1.00}Ni_{0.33}Mn_{0.33}CO_{0.33}O₂. In a more particular embodiment, the active material is Li₁₊ₓM_{1-y}O₂ wherein M is selected from Mn, Ni, Co, Al or a mixture thereof, and wherein 0<x≤1 and 0<y≤0.33.

In a more particular embodiment, the salt comprising a C₃₋₆ oxocarbon anion group is an alkali metal C₃₋₆ oxocarbon salt or mixture of salts; preferably an alkali metal C₃₋₆ oxocarbon salt or mixture of salts, wherein the alkali metal is selected from the group consisting of lithium, sodium, potassium and mixtures thereof.

In a more particular embodiment, the salt comprising a C₃₋₆ oxocarbon anion group is a lithium C₃₋₆ oxocarbon salt.

In a particular embodiment, the C₃₋₆ oxocarbon anion group is a partially hydrogenated anion or a non-hydrogenated anion; preferably a non-hydrogenated anion.

In a particular embodiment, the C₃₋₆ oxocarbon anion group is selected from the group consisting of deltate, mesoxalate, acetylenedicarboxylate, squarate, dioxosuccinate, croconate, methanetetracarboxylate, rhodizonate, benzoquinonetetraolate, benzenehexolate, ethylenetetracarboxylate and mixtures thereof; preferably is selected from the group consisting of acetylenedicarboxylate, squarate, dioxosuccinate, croconate, methanetetracarboxylate, rhodizonate, benzoquinonetetraolate, benzenehexolate, ethylenetetracarboxylate and mixtures thereof; more preferably from the group consisting of acetylenedicarboxylate, squarate, dioxosuccinate, croconate, methanetetracarboxylate, and mixtures thereof; even more preferably from the group consisting of acetylenedicarboxylate, squarate, dioxosuccinate and mixtures thereof; even much more preferably is squarate.

In a more particular embodiment, the salt comprising a C₃₋₆ oxocarbon anion group is lithium squarate (Li₂C₄O₄).

In an embodiment, the mixture of the electrode further comprises a conductive material.

In a particular embodiment, the conductive material in the mixture is a conductive carbonaceous material; preferably conductive carbon black, more preferably C65 carbon black.

In the context of the present invention, the expression “carbon black” refers to what is commonly understood in the art by said expression, i.e. a form of paracrystalline carbon that has a high surface-area-to-volume ratio, although lower than that of activated carbon.

In an embodiment, the mixture further comprises a binder. In a particular embodiment, the binder of the mixture is a thermoplastic polymer, copolymer or mixtures thereof; more preferably a thermoplastic polymer, copolymer or mixtures thereof comprising an halogen group; preferably a thermoplastic polymer, copolymer or mixtures thereof comprising fluorine; more preferably is a vinyl polymer comprising fluorine; even much more preferably is poly(vinylidene difluoride) (PVDF).

In an embodiment, the active material and the salt in the mixture are in a mass ratio equal or between 100:0.2 and 100:90; preferably in a mass ratio equal or between 100:0.5 and 100:85; more preferably in a mass ratio equal or between 100:1 and 100:70; even more preferably in a mass ratio equal or between 100:18 and 100:30, more preferably of about 100:20 respectively.

In another embodiment, the active material and the binder are in a mass ratio equal or between 100:0.1 and 100:50; preferably of equal or between 100:05 and 100:30; more preferably of between 100:03 and 100:15 respectively.

In an embodiment, the active material, the conductive carbonaceous material and the binder are in mass ratios equal or between 60:30:10 and 92:5:3 respectively.

In a particular embodiment, the mixture consists of an active material, a binder, a conductive carbonaceous material, and a salt comprising a C₃₋₆ oxocarbon anion group, preferably wherein the C₃₋₆ oxocarbon anion group is a C₃₋₆ oxocarbon lithium salt.

In a particular embodiment, the mixture consists of an active material comprising lithium, a binder, a conductive carbonaceous material, and lithium squarate.

### Current Collectors

In a particular embodiment, the current collectors are metallic current collectors; preferably are a current collectors made of a metal or an alloy; preferably of aluminium, copper, nickel, stainless steel or a mixture thereof; more preferably of aluminium and/or copper.

In a particular embodiment, the cell comprises two current collectors:
wherein the surface of at least one of the sides of one current collector is in contact with the mixture of the electrode of the cell and
wherein the all surface of at least one of the sides of the other current collector is in contact with the electrolyte.

In a particular embodiment, the surface of at least one of the sides of one current collector is in contact with the mixture of the electrode of the cell; preferably the surface of at least one of the sides of one current collector is coated with the mixture of the electrode of the cell; more preferably the surface of at least one of the sides of one current collector is coated with a layer of the mixture of the electrode of the cell; even more preferably all the surface of at least one of the sides of one current collector is coated with a layer of the mixture of the electrode of the cell; particularly in direct physical contact.

In a particular embodiment, all the surface of at least one of the sides of one current collector is in contact with the electrolyte; particularly in direct physical contact with the electrolyte.

In a more particular embodiment, the cell comprises two current collectors; wherein one current collector is in contact with the mixture of the cell and wherein the other current collector is in contact with the electrolyte; and preferably wherein the current collector in contact with the mixture is made of aluminium and the current collector in contact with the electrolyte is made of copper.

### Electrolyte

In an embodiment, the electrolyte comprises active species. The term “active species” refers to electroactive species that may electrochemically react on the electrodes of a cell as known in the art.

In a particular embodiment, the electrolyte comprises an alkali metal compound and a solvent or solvent mixture.

In another particular embodiment, the electrolyte consists of an alkali metal compound and a solvent or solvent mixture; preferably the electrolyte consists of a lithium compound and a solvent or solvent mixture; more preferably the electrolyte consists of a lithium salt and a solvent or solvent mixture.

In a particular embodiment, the electrolyte comprises an alkali metal compound; preferably a lithium compound; preferably a lithium compound selected from the group consisting of lithium salts, lithium conducting polymers and mixtures thereof.

Non-limiting examples of lithium compounds suitable for the electrolyte are LiPF₆, LiBF₄, LiBF₆, LiASF₆, LiClO₄, LiSbF₆, LiCF₃SO₃Li, LiC₄F_{g}SO₃, LiAlF₄, LiAlCl₄, LiCl, LiI, lithium-based sulfonimides such as LiN(CₓF₂ₓ₊₁SO₂)(C_{y}F_{2+y}SO₂) wherein x and y are natural numbers being 0≤x≤4 and 0≤y≤4, for example lithium bis(fluorosulfonyl)imide (LiFSI) or lithium bis(trifluoromethane)sulfonimide (LiTFSI) lithium poly(styrene sulfonyl-trifluoromethane sulfonimide) (LiPSTFSI), lithium poly(acrylamidopropyl sulfonyl-trifluoromethane sulfonimide) (LiMAPTFSI), lithium poly(methacrylamidopropyl sulfonyl-trifluoromethane sulfonimide) (LIMMPTFSI), lithium 4,5-dicyano-2-(trifluoromethyl)imidazole (LiTDI), and mixtures thereof.

In a more particular embodiment, the electrolyte comprises lithium hexafluorophosphate (LiPF₆).

In a particular embodiment, the electrolyte comprises an organic solvent selected from compounds comprising a carbonate group, an ester group, an ether group, a ketone group, an alcohol group, or a combination thereof; preferably compounds comprising a carbonate group, an ether group or a combination thereof.

In an embodiment, compounds comprising a carbonate group suitable as solvent are linear or cyclic carbonates.

In an embodiment, compounds comprising a carbonate group suitable as solvent are selected from alkyl carbonates such as dimethylcarbonate, (DMC), diethylcarbonate (DEC), dipropyl carbonate (DPC), ethyl-methyl carbonate (EMC), methyl propyl carbonate (MPC), ethyl propyl carbonate (EPC), or mixtures thereof; alkylene carbonates such as ethylene carbonate (EC); fluorinated carbonates such as fluorinated cyclic carbonate (F-AEC) or fluorinated linear carbonate (F-EMC), and mixtures thereof. In a particular embodiment, compounds suitable as solvent are fluorinated organic compounds, preferably fluorinated ethers such as fluorinated ether (F-EPE), hydro fluoro ethers and mixtures thereof. In a particular embodiment, the electrolyte comprises an ethylene carbonate (EC) and dimethyl carbonate (DMC) mixture; even much more preferably an ethylene carbonate (EC) and dimethyl carbonate (DMC) mixture being in a mass ratio of between 1:0.5 and 1:2; preferably of between 1:0.8 and 1:1.5; much more preferably of about 1:1.

In a particular embodiment, the electrolyte comprises a lithium salt and a mixture of carbonates; more preferably a lithium hexafluorophosphate (LiPF₆) and a ethylene carbonate (EC) and dimethyl carbonate (DMC) mixture; more preferably wherein the ethylene carbonate (EC) and dimethyl carbonate (DMC) are in a mass ratio of between 1:0.5 and 1:2; preferably of between 1:0.8 and 1:1.5; much more preferably of about 1:1. In a particular embodiment, the electrolyte consists of a lithium salt and a mixture of carbonates; more preferably a lithium hexafluorophosphate (LiPF₆) and a ethylene carbonate (EC) and dimethyl carbonate (DMC) mixture; more preferably wherein the ethylene carbonate (EC) and dimethyl carbonate (DMC) are in a mass ratio of between 1:0.5 and 1:2; preferably of between 1:0.8 and 1:1.5; much more preferably of about 1:1.

In a particular embodiment, the electrolyte is a liquid electrolyte.

### Separator

Any separator known in the art related to anode-free electrochemical cells may be used in the present invention. In a particular embodiment, the separator is made of an electrically insulating material. Non-limiting materials suitable for the separator are insulating polymers with or without ceramic coating, such as polycarbonate or polypropylene, cellulose based materials such as paper, glass fiber, etc.

In an embodiment, the separator is between the electrolyte and the mixture of the cell; preferably being in contact with the electrolyte and with the mixture; more preferably wherein the separator comprises two sides and wherein one side is in contact with the electrolyte and the other side is in contact with the mixture.

In an embodiment, the separator is a membrane, preferably a glass fiber or a polypropylene membrane.

In an embodiment, the anode-free electrochemical cell (1) of the present invention consist of:
an electrode (5) comprising a mixture comprising:
   an active material, and
   a salt comprising a C₃₋₆ oxocarbon anion group;
an electrolyte (4);
a separator; and
two current collectors (2, 3);
   wherein the electrode (5) is a cathode.

An aspect of the invention is directed to a method of manufacturing the cell of the invention in any of its particular embodiments, said method comprises an electrode preparation step that comprises:
(i) providing at least the following materials:
   a. an active material,
   b. a salt comprising a C₃₋₆ oxocarbon anion group; and
   c. a solvent;
(ii) mixing the materials of step (i) to form a mixture;
(iii) casting the mixture on a current collector; and
(iv) drying the mixture to form an electrode.

### Electrode Preparation

In a particular embodiment, the electrode preparation step comprises:
(i) providing at least the following materials:
   a. an active material,
   b. a salt comprising a C₃₋₆ oxocarbon anion; preferably a C₃₋₆ oxocarbon lithium salt; and
   c. a solvent;
(ii) mixing the materials of step (i) to form a mixture;
(iii) casting the mixture of step (ii) on a current collector; and
(iv) drying the mixture.

In a particular embodiment, the active material of step (i) is any of the active materials described above in any of the particular embodiments regarding the cell.

In an embodiment, the electrode of the electrode preparation step of the method of manufacturing the cell, is the cathode of said cell.

In a particular embodiment, the step (i) and the mixture of step (ii) further comprises a binder; preferably the binder is any of the binders described above in any of the particular embodiments regarding the cell.

In a particular embodiment, the step (i) and the mixture of step (ii) further comprises a conductive material; preferably the conductive material is any of the conductive materials described above in any of the particular embodiments regarding the cell.

In a particular embodiment, the C₃₋₆ oxocarbon anion group of the salt is a partially hydrogenated anion or a non-hydrogenated anion; preferably a non-hydrogenated anion. In a particular embodiment, the C₃₋₆ oxocarbon anion group of the salt is selected from the group consisting of deltate, mesoxalate, acetylenedicarboxylate, squarate, dioxosuccinate, croconate, methanetetracarboxylate, rhodizonate, benzoquinonetetraolate, benzenehexolate, ethylenetetracarboxylate and mixtures thereof; preferably from the group consisting of acetylenedicarboxylate, squarate, dioxosuccinate, croconate, methanetetracarboxylate, rhodizonate, benzoquinonetetraolate, benzenehexolate, ethylenetetracarboxylate and mixtures thereof; more preferably from the group consisting of acetylenedicarboxylate, squarate, dioxosuccinate, croconate, methanetetracarboxylate, and mixtures thereof; even more preferably from the group consisting of acetylenedicarboxylate, squarate, dioxosuccinate and mixtures thereof; even much more preferably is squarate.

In a more particular embodiment, the salt comprising a C₃₋₆ oxocarbon anion group is a lithium C₃₋₆ oxocarbon salt; preferably a lithium squarate (Li₂C₄O₄).

In a particular embodiment, the solvent of step (i) is an organic solvent; more preferably an organic compound comprising an amide; even more preferably an organic compound comprising a cyclic amide; much more preferably a pyrrolidone such as N-methyl-2-pyrrolidone (NMP).

In an embodiment, the active material and the salt are in a mass ratio equal or between 100:0.2 and 100:90; preferably in a mass ratio equal or between 100:0.5 and 100:85; more preferably in a mass ratio equal or between 100:1 and 100:70; even more preferably in a mass ratio equal or between 100:18 and 100:30, more preferably of about 100:20 respectively.

In a particular embodiment, the mixture was casted by doctor blade or tape casting method.

In a particular embodiment, the mixture was casted on step (iii) so as a wet thickness of between 50 and 400 microns is obtained; preferably of between 100 and 300 microns; more preferably of between 150 and 250 microns; even much more preferably of about 200 microns.

In a particular embodiment, the current collector of step (iii) is one of the two current collectors of the cell.

In a particular embodiment, the current collector of step (iii) is a film; preferably a metallic foil; more preferably an aluminium foil.

In a particular embodiment, step (iv) comprises drying the mixture at between 50 and 150° C.; preferably at between 60 and 120° C.; more preferably at between 70 and 100° C.; even much more preferably at about 80° C.

In a particular embodiment, step (iv) comprises drying the mixture during between 1 min and 24 h; preferably for between 10 min and 20 h; more preferably for between 30 min and 15 h; more preferably for about 12 h.

In a particular embodiment, step (iv) comprises drying the mixture in an oven; preferably in a vacuum oven.

In a particular embodiment, the process further comprises a step (v) where the dried mixture resulting from step (iv) is subjected to compression in order to reduce its thickness. Said process can be carried out by hot and/or cold densification or by calendaring, and they are widely known by a skilled person.

For example, densification can be carried out by hot pressing during which controlled pressure and temperature are applied simultaneously to mold the product.

Alternatively, the dried mixture can be subjected to calendaring which implies smoothing and compressing the mixture by passing it through a number of pairs of heated rolls.

The temperature in both processes is preferably between 25° C. and 150° C., more preferably between 60° C. and 150° C., even more preferably between 80° C. and 130° C.

In a particular embodiment, the thickness of the dried mixture is reduced between 5% and 50% regarding the wet thickness of the same mixture.

In an embodiment, the method of manufacturing the cell of the present invention further comprises:
(v) providing the following elements: a separator, an additional current collector and an electrolyte and
(vi) assembling all of the elements of step (v) with the electrode of step (iv) to from the cell;
   wherein only the current collector of step (iii) is in contact with the mixture of the electrode and
   preferably wherein the separator is placed between the electrolyte and the electrode.

The authors of the present invention have observed that the use of an electrode comprising a mixture as described above in the cell of the present invention, lead to high values of charge capacity.

### Energy Storage or Supply System

In a second aspect, the present invention is directed to an energy storage or supply system comprising one or more cells as defined above in any of their particular embodiments.

### Uses

Additional aspects of the present invention are directed to the use of the cell as defined above in any of its particular embodiments or of the energy storage or supply system defined above to store or supply energy, particularly, in the renewable energy and electromobility sectors

An aspect of the invention is directed to a method for storing energy or supplying energy comprising using the cell of the invention as defined in any of the particular embodiments.

To this end, the cell of the present invention may be used individually or in combination with other energy storage technologies and may be integrated into or with various systems and/or devices to improve efficiency, address energy demands, etc.

Furthermore, the cell of the invention may be used in a variety of applications having different energy supply and/or storage needs, including, but not limited to, very large scale applications (e.g., utilities, functioning as a green energy source for a smart grid, energy storage for use in combination with renewable energy resources such as wind and solar power, etc.) and smaller applications (e.g. backup power, residential power, electromobility sector, etc.).

Throughout the description and claims the word “comprises” and variations of the word, are not intended to exclude other technical features, additives, components or steps. Furthermore, the word “comprise” encompasses the case of “consisting of”. Additional objects, advantages and features of the invention will become apparent to those skilled in the art upon examination of the description or may be learned by practice of the invention.

The present invention will be described in further detail with reference to the following examples. These examples are for illustrative purposes only and are not intended to limit the scope of the present invention.

### EXAMPLES

### Example 1—Battery Cell Preparation

An anode-free lithium metal battery (AFLMB) cell was prepared with a cathode composite comprising Li_{1.00}Ni_{0.33}Mn_{0.33}CO_{0.33}O₂ (NMC 111) as active material and a lithium squarate (Li₂C₄O₄) salt on Al foil (said Al foil acting as cathode current collector), 1M LiPF₆ in ethylene carbonate (EC) and dimethyl carbonate (DMC) being in a mass ratio EC:DMC of 50:50 as electrolyte, glass fiber as separator, Cu foil and said Al foil as current collectors.

The cathode composite was prepared as follows: a slurry was prepared by mixing (a) the active material (NMC 111), super carbon C65 and poly(vinylidene difluoride) (PVDF) in a mass ratio of 80:10:10 with (b) lithium squarate (Li₂C₄O₄) salt/C65 (in a 70/30 wt %), in N-methyl-2-pyrrolidone (NMP). The mixture was kept under vigorous stirring for 1 h by using a mechanical stirrer equipment. The slurry was then casted onto an aluminum current-collector foil using a Dr. Blade instrument with a controlled wet thickness of 200 microns and afterwards dried in a vacuum oven at 80° C. for 12 h. Electrodes were not pressed before being assembled in the battery. The cathode composite composition of the battery of the present example comprises Li_{1.00}Ni_{0.33}Mn_{0.33}CO_{0.33}O₂ (NMC 111) as active material and a lithium squarate (Li₂C₄O₄) salt in a mass ratio of about 100:20 respectively.

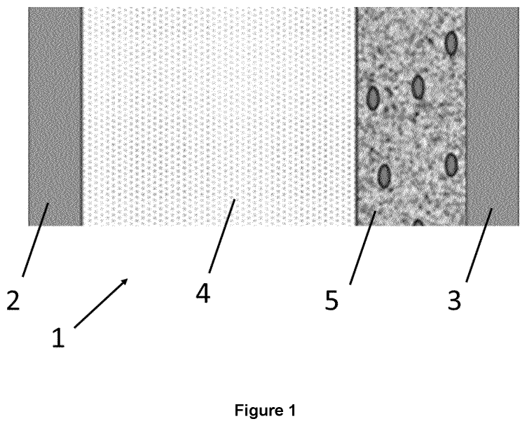

FIG. 1 shows a particular embodiment of the battery cell (1) comprising a Cu current collector (2), a second current collector (3), EC/DMC/LiPF₆ electrolyte (4) and a positive electrode comprising an active material and a salt composite (5).

### Example 2—Battery Cell Test

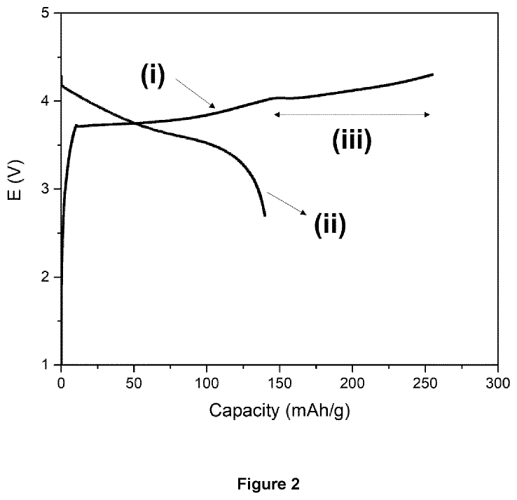

FIG. 2 shows the initial charge/discharge profiles of the battery cell of Example 1 showing voltage (V) versus specific capacity (mAh/g) results of (i) initial charge and (ii) initial discharge. FIG. 2 shows on (iii) a capacity excess due to the use of Li squarate salt as cathode additive. In particular, results show that the Li squarate salt (Li₂C₄O₄) oxidizes in the initial charge giving rise to additional capacity. This enables the reversal intercalation of the Li+ ions back into the cathode with a capacity of 140 mAh/g as can be observed on FIG. 2.

In addition, results show that the cathode composition leads to a cut off potential of 4.3V which falls within the conventional charging potential of an NMC cathode, thereby preventing ageing of electrolyte and cathode material decomposition and improving the overall battery life and cyclability of the system, especially at high fast charges.

### Example 3—Comparative Test

A comparative test was performed with battery cells similar to the one described in Example 1 but comprising either lithium squarate salt or lithium oxalate as salt additive in the cathode composite.

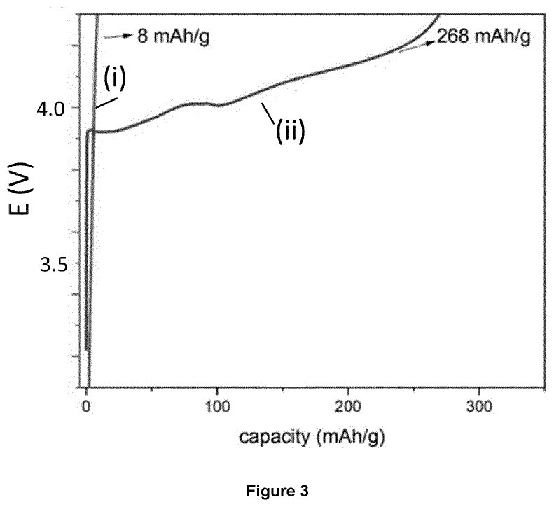

FIG. 3 shows the charge capacity of a battery cell comprising either (i) lithium oxalate or (ii) lithium squarate salt additive mixed with Super carbon C65 at C/10 within a cutoff potential of 4.3V. FIG. 3 shows a charge capacity (additional Lithium) of only 8 mAh/g for lithium oxalate salt, whereas a charge capacity of 268 mAh/g was obtained for the squarate salt.

1. An anode-free electrochemical cell (1) comprising:
an electrode (5) comprising a mixture comprising:
an active material, and
a salt comprising a C₃₋₆ oxocarbon anion group;
an electrolyte (4);
a separator; and
two current collectors (2, 3);
wherein the electrode (5) is a cathode; and
wherein the oxocarbon anion group is squarate.

2. (canceled)

3. (canceled)

4. The cell according to claim 1, wherein the salt is a lithium salt.

5. The cell according to claim 4, wherein the salt is lithium squarate.

6. The cell according to claim 1, wherein the active material is selected from lithium nickel manganese cobalt oxide (NMC), lithium nickel manganese oxide (LNMO), lithium nickel cobalt aluminium oxide (NCA), lithium manganese oxide (LMO), lithium cobalt oxide (LCO) or mixtures thereof.

7. The cell according to claim 6, wherein the active material is lithium nickel cobalt manganese oxide (NMC).

8. The cell according to claim 1, wherein the active material and the salt in the mixture are in a mass ratio equal or between 100:0.2 and 100:90.

9. The cell according to claim 1, wherein the mixture consist of an active material comprising lithium, lithium squarate, a conductive material and a binder.

10. The cell according to claim 1, wherein the electrolyte comprises:
a lithium compound selected from the group consisting of lithium salts, lithium conducting polymers and mixtures thereof; and
compounds comprising a carbonate group selected from alkyl carbonates, alkylene carbonates, fluorinated carbonates, and mixtures thereof.

11. The cell according to claim 10, wherein the electrolyte comprises: lithium hexafluorophosphate (LiPF₆) and an ethylene carbonate (EC) and dimethyl carbonate (DMC) mixture; wherein the ethylene carbonate (EC) and dimethyl carbonate (DMC) are in a mass ratio of between 1:0.5 and 1:2.

12. The cell according to claim 1, wherein all the surface of at least one of the sides of one of the two current collectors is in contact with the electrolyte and wherein the other one of the two current collectors is in contact with the mixture of the electrode of the cell.

13. The cell according to claim 1, wherein the electrolyte comprises: lithium hexafluorophosphate (LiPF₆) and an ethylene carbonate (EC) and dimethyl carbonate (DMC) mixture; wherein the ethylene carbonate (EC) and dimethyl carbonate (DMC) are in a mass ratio of between 1:0.5 and 1:2; and wherein the active material is selected from lithium nickel manganese cobalt oxide (NMC), lithium nickel manganese oxide (LNMO), lithium nickel cobalt aluminium oxide (NCA), lithium manganese oxide (LMO), lithium cobalt oxide (LCO) or mixtures thereof.

14. The cell according to claim 1, wherein the active material and the salt in the mixture are in a mass ratio equal or between 100:18 and 100:30.

15. The cell according to claim 1, wherein the cell (1) consist of:
an electrode (5) comprising a mixture comprising:
an active material, and
a salt comprising a C₃₋₆ oxocarbon anion group;
an electrolyte (4);
a separator; and
two current collectors (2, 3);
wherein the electrode (5) is a cathode; and
wherein the oxocarbon anion group is squarate.

16. A method of manufacturing the cell according to claim 1, comprising an electrode preparation step that comprises:
(i) providing at least the following materials:
a. an active material,
b. a salt comprising a C₃₋₆ oxocarbon anion group; wherein the oxocarbon anion group is squarate; and
c. a solvent;
(ii) mixing the materials of step (i) to form a mixture;
(iii) casting the mixture on a current collector; and
(iv) drying the mixture to form an electrode.

17. An energy storage or supply system comprising one or more cells according to claim 1.

18. (canceled)
